(19) United States
(12) Patent Application Publication
(10) Pub. No.: US 2017/0003877 A1
(43) Pub. Date: Jan. 5, 2017

(54) METHOD AND DEVICE FOR MOTION-SENSING KEY POSITIONING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Duan XU, Tianjin (CN); Chao ZANG, Tianjin (CN)

(21) Appl. No.: 15/232,543

(22) Filed: Aug. 9, 2016

Related U.S. Application Data
(63) Continuation of application No. PCT/CN2016/088207, filed on Jul. 1, 2016.

(30) Foreign Application Priority Data
Jul. 1, 2015 (CN) 201510377342.X

(51) Int. Cl. G06F 3/0488; G06K 9/00; G06F 3/01; G06T 7/00

(52) U.S. Cl. CPC G06F 3/04886; G06T 7/0044; G06K 9/00355; G06F 3/017

(57) ABSTRACT

The embodiment of the present disclosure discloses a motion-sensing key positioning method and a motion-sensing key positioning device. The positioning method comprises the following steps: firstly, determining a unified reference point coordinate value of all motion-sensing keys according to a hand point coordinate value acquired at the first time; secondly, segmenting a pre-defined region so as to obtain segmented sub-regions according to layout of the motion-sensing keys; and finally, determining corresponding segmented sub-regions according to the hand point coordinate values acquired in real time after the first hand point acquisition and reference point coordinate values so as to position the corresponding motion-sensing keys. A plurality of segmented sub-regions are formed in the present disclosure; and therefore, the hand shape does not need to be displayed, direct operation can be performed by small-amplitude motion-sensing action, and the blank part is not clicked.

### CROSS-REFERENCE TO RELATED APPLICATIONS

This application is a continuation of International Application No. PCT/CN2016/088207 filed on Jul. 1, 2016 which is based upon and claims priority to Chinese Patent Application No. 201510377342.X, filed on Jul. 1, 2015, the entire contents of which are incorporated herein by reference.

### TECHNICAL FIELD

The disclosure generally relates to the technical field of motion sensing control and in particular relates to a motion-sensing key positioning method and a motion-sensing key positioning device.

### BACKGROUND

Motion sensing control lies in that people can directly use body action to interact with surrounding devices or environments without using any complex control equipment so as to interact with the contents personally on the scene. For example, when a person stands in front of a TV, if certain motion-sensing equipment can sense action of the hands, then if the person waves the hands upwards, downwards, towards the left and towards the right respectively to control quick turn, fast backward, pause, termination and other functions of TV stations, an example of directly controlling the surrounding devices through motion sensing is obtained; or the four actions directly correspond to responses of game roles, and people can get game experiences personally on the scene.

In the previous motion-sensing control process, a “hand shape” similar to a cursor generally presents in a human-computer interaction interface, and movement of the “hand shape” and trigger of corresponding function keys are controlled by capturing body action of an operator. However, in the prior art, the body action is generally moved and switched in a wide range in the motion-sensing control process, so that the “hand shape” can be controlled; meanwhile, in the motion-sensing control process, the operator needs to pay attention to control of the “hand shape” at all times so as not to easily divide attention of the operator; and moreover, the body action is generated by wide-range movement, a blank part can be easily clicked, and control of the “hand shape” fails.

### SUMMARY

In consideration of the previous problems, the embodiment of the present disclosure discloses a motion-sensing key positioning method and a motion-sensing key positioning device used for solving the problems in the prior art that body action is generally moved and switched in a wide range in the motion-sensing control process, the attention of the operator is easily divided and a blank part can be easily clicked.

According to one aspect of the present disclosure, the embodiment of the present disclosure provides a motion-sensing key positioning method, including:
determining reference point coordinate values of all motion-sensing keys according to hand point coordinate values acquired at the first time;
segmenting a pre-defined region to obtain segmented sub-regions of which the number corresponds to that of the motion-sensing keys according to the layout and number of the motion-sensing keys;
determining corresponding segmented sub-regions according to differences between the hand point coordinate values acquired in real time after the first acquisition and the reference point coordinate values so as to position the corresponding motion-sensing keys.

According to another aspect of the present disclosure, the embodiment of the present disclosure further discloses a motion-sensing key positioning device, including:
a reference point coordinate value determining unit, used for determining reference point coordinate values of all the motion-sensing keys according to hand point coordinate values acquired at the first time;
a segmenting unit used for segmenting a pre-defined region to obtain segmented sub-regions of which the number corresponds to that of the motion-sensing keys according to the layout and number of the motion-sensing keys;
a positioning unit, used for determining corresponding segmented sub-regions according to differences between the hand point coordinate values acquired in real time after the first acquisition and the reference point coordinate values so as to position the corresponding motion-sensing keys.

According to another aspect of the present disclosure, the present disclosure provides a computer program, including computer readable codes, and when the computer readable codes are operated on intelligent electrical device, a method for positioning motion-sensing keys executed on the intelligent electrical device is provided.

According to another aspect of the present disclosure, the present disclosure discloses a computer readable medium in which the previous computer program is stored.

The present disclosure has the beneficial effects that:
According to the motion-sensing key positioning method and the motion-sensing key positioning device provided by the embodiment of the present disclosure, the pre-defined region is segmented and computed to obtain corresponding percentages of the segmented sub-regions, and the corresponding segmented sub-regions operated at present are determined according to the percentage computed by the differences between the real-time hand point coordinate values and the reference point coordinate values so as to position the corresponding motion-sensing keys. Therefore, specific motion-sensing keys can be positioned based on corresponding relations between the segmented sub-regions and the motion-sensing keys; and therefore, the hand shape does not need to be displayed, the operation can be directly performed by small-amplitude motion-sensing action only, the blank part is not clicked, and errors in operation are reduced.

The description above is only the summary of the technical scheme of the present disclosure, in order to clearly know the technical measures of the present disclosure and implement the measures according to the contents of the specification, and in order to enable the previous and other aims, characteristics and advantages of the present disclosure to be obvious and easy to understand, the specific embodiments of the present disclosures are particularly listed in the followings:

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the flow chart of the motion-sensing key positioning method provided by the embodiment I of the present disclosure.

FIG. 2 shows the segmentation diagram of the present disclosure in a 2D rectangular coordinate system.

FIG. 3 shows the segmentation diagram of the present disclosure in the 2D polar coordinate system.

FIG. 4 shows the flow chart of motion-sensing key positioning in the embodiment I of the present disclosure.

FIG. 5 shows a flow chart of motion-sensing key positioning in the embodiment II of the present disclosure.

FIG. 6 shows a structure diagram of the motion-sensing key positioning device provided by the embodiment of the present disclosure.

FIG. 7 schematically shows the block diagram of intelligent electrical device for executing the method according to the present disclosure.

FIG. 8 schematically shows a storage unit used for keeping or carrying the program codes for realizing the method according to the present disclosure.

### DETAILED DESCRIPTION

In order to enable the aims, technical schemes and advantages of the embodiments of the present disclosure to be clear, the technical schemes in the embodiments of the present disclosure are clearly and completely described by combining the following figures in the embodiments of the present disclosure, the described embodiments are not total embodiments, but one part of the embodiments of the present disclosure. Based on the embodiments in the present disclosure, all other embodiments obtained by the common technicians in the field under the condition that creative labor is not contributed belong to the protection scope of the present disclosure.

The motion-sensing key positioning method provided by the present disclosure is applied to intelligent electrical device such as smart televisions and the like. The intelligent electrical device is connected with an image acquisition device such as a motion-sensing camera. The intelligent electrical device can be connected with the image acquisition device by virtue of a USB cable, and the camera can be built in the intelligent electrical device.

The image acquisition device identifies the acquired image data, when a target object is identified, position information of the target object is analyzed and transmitted to the intelligent electrical device, and the intelligent electrical device acquires the position information of the target object, wherein the position information refers to a hand point. Certainly, the image acquisition device also can directly transmit the acquired image data to the intelligent electrical device, and the image data is identified by the intelligent electrical device so as to acquire the position information of the target object.

In order to well reflect the position in which the target object is positioned, a coordinate system is established at a position in which the image acquisition device is positioned in the present disclosure, and the position information of the present disclosure refers to point information (hand point) of the target object in the coordinate system, wherein the coordinate system CM be either a two-dimensional coordinate system, as three-dimensional coordinate system and a polar coordinate system.

The operation of identifying the acquired image in the present disclosure also refers to an operation of identifying the target object in the image so as to acquired the position information by using an existing image recognition algorithm, for example, a kinect and tof method is adopted to acquire the point information (hand point) of the target object in the coordinate system; and therefore, unnecessary details are avoided.

Specifically, the target object refers to hands, head or other limbs, even certain operating devices such as joysticks, sensing gloves and the like.

FIG. 1 shows the flow chart of the motion-sensing key positioning method provided by the embodiment I of the present disclosure; as shown in the FIG. 1, in the embodiment, the method includes:
S101, determining reference point coordinate values of all motion-sensing keys according to hand point coordinate values acquired at the first time.

The acquisition device acquires hand points by taking preset time length as a period, the preset time length is set according to system needs, if an operating event of the identification object is hoped to be accurately identified, the preset time length is set to be shorter time length, otherwise longer time length, and the preset time length can be set according to performances of monitors and data processors, for example, when the identifier or data processor is powerful in performance and high in speed the preset time length can be set to be shorter. In the embodiment, when a firsthand point is acquired, the hand point acquired at the first time is recorded or saved, and the step of determining the reference point coordinate values of all motion-sensing keys according to hand point coordinate values acquired at the first time includes the sub-steps: determining a preset length by taking the hand point acquired at the first time as a center after the hand point is acquired at the first time, subtracting one half of the preset length from the hand point coordinate value acquired at the first time, and generating the reference point coordinate values of all the motion-sensing keys. For example, in a 2D rectangular coordinate system, the hand point coordinate value acquired at the first time can be a hand point XY coordinate value or a hand point YZ coordinate value; if in a 2D polar coordinate system, the hand point XY coordinate value can be converted into a hand point polar coordinate value according to a corresponding relationship of the 2D rectangular coordinate system and the 2D polar coordinate system, namely the hand point coordinate value acquired at the first time can be reflected by virtue of polar angle and polar diameter. Taking the 2D rectangular coordinate system as an example, when the hand point acquired at the first time is P0(X0, Y0) and the preset length is L, the reference point coordinate is P (X0−L/2, Y0−L/2).

To be described is that determination of the reference point coordinate value is not limited to determination of subtracting one half of the preset length from the hand point coordinate value acquired at the first time; and in the actual application process, the reference point coordinate values can be determined according to the number of the motion-sensing keys.

In the embodiment, modes of the acquisition device used for acquiring the motion-sensing action can include inertial sensing, optical sensing and inertia and optical combined sensing.

The inertial sensing mainly includes the steps of sensing physical parameters such as acceleration, angular velocity and magnetic field of body action of a user by using principle inertial sensors such as a gravity sensor, a gyroscope, a magnetic sensor and the like, and solving various types of action of the user in a space according to the physical parameters.

The optical sensing mainly includes the steps: acquiring a human body image through an optical sensor, and interacting body action of the human body image with contents in the game, wherein a 2D plane serves as a main plane, and most of the contents belong to simple types of interactive games. Furthermore, the human body image information can be acquired by using laser and cameras (RGB), and the 3D entire image of the human body can be acquired so as to provide more advanced depth information.

The inertia and optical combined sensing can be performed by placing a gravity sensor on a handle to be used for sensing three-axial acceleration of the hand, and placing an infrared sensor to be used for sensing an infrared emitter signal in front of the TV screen. The sensor can be used for mainly sensing displacement of the hand in the vertical and horizontal directions so as to control a space mouse, so that human wrist rotation and other action can be accurately sensed experience in the motion sensing aspect is enhanced.

Therefore, acquisition of the first-time hand point coordinate value can be based on an inertial sensor, or an optical sensor or a combination of the optical sensor and the inertial sensor.

S102, segmenting the pre-defined region so as to obtain segmented sub-regions according to the layout of the motion-sensing keys.

In the embodiment, the step of segmenting the pre-defined region so as to obtain the segmented sub-regions according to the layout of the motion-sensing keys includes the sub-steps:
segmenting the pre-defined region along the layout direction of the motion-sensing keys so as to obtain segmented sub-regions of which the number corresponds to that of the motion-sensing keys according to the layout and number of the motion-sensing keys, wherein the layout of the motion-sensing keys includes position relation, size and layout direction of the motion-sensing keys. The pre-defined region can be optionally set and is used for mapping the motion-sensing keys in a display interface, each segmented sub-region corresponds to a motion-sensing key, the size and position relation correspond to the motion-sensing keys, and the sub-regions can be narrowed or magnified for the motion-sensing keys according to a ratio.

When the pre-defined region is segmented to obtain the segmented sub-regions, the defined sub-regions are segmented into more rectangular segmented sub-regions, each motion-sensing key corresponds to multiple segmented sub-regions so as to accurately and subsequently position the motion-sensing keys.

Furthermore, the step of segmenting the pre-defined region along the layout direction of the motion-sensing keys so as to obtain segmented sub-regions of which the number corresponds to that of the motion-sensing keys according to the layout and number of the motion-sensing keys includes the following sub-steps: segmenting the pre-defined region along a transverse direction so as to obtain segmented sub-regions of which the number corresponds to that of the motion-sensing keys in the transverse direction according to the number of the motion-sensing keys in the transverse direction; and/or segmenting the pre-defined region along a longitudinal direction so as to obtain segmented sub-regions of which the number corresponds to that of the motion-sensing keys in the longitudinal direction according to the number of the motion-sensing keys in the longitudinal direction. When only a column or a row of motion-sensing keys exist, the pre-defined region only needs to be segmented along the arrangement direction, and when the motion-sensing keys have both transverse layout and longitudinal layout on the display interface, the pre-defined region. needs to be segmented in two directions.

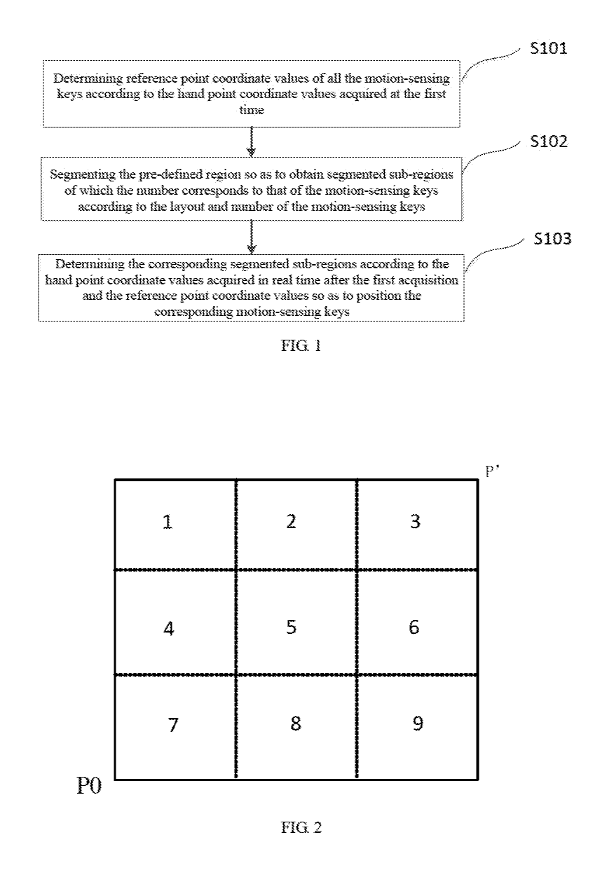

Specifically, FIG. 2 shows a segmentation diagram of the present disclosure in the 2D rectangular coordinate system; if nine motion-sensing keys are set in the display interface, the keys are arranged in a Sudoku manner, and the size of each key is the same. Firstly, a pre-defined region is created, can be large or small, is set according to user requirements, can correspond to the display interface and also can correspond to layout regions of the motion-sensing keys on the display interface one by one, preferably the pre-defined region can be set to be the same as the layout regions of the motion-sensing keys. The layout directions of the nine motion-sensing keys are transverse direction and longitudinal direction, the pre-defined region is transversely and longitudinally segmented so as to obtain nine segmented sub-regions of which the number corresponds to that of the motion-sensing keys along the transverse direction and longitudinal direction according to the nine motion-sensing keys and the Sudoku layout manner, the operation specifically includes the steps: segmenting the pre-defined region into three equal segmented sub-regions in the transverse direction, segmenting the three segmented sub-regions obtained by segmenting the pre-defined region in the longitudinal direction, segmenting into 3*3 segmented sub-regions, thereby obtaining totally nine rectangular segmented sub-regions so as to establish a one-to-one relationship between each segmented sub-region and the motion-sensing keys, wherein the sequence of the transverse and longitudinal segmentation is not limited.

When the target object drops in the segmented sub-regions, determining that the target object has selected corresponding motion-sensing keys in the segmented sub-regions at present, further identifying the operating event of the target object so as to determine whether to perform operating control on the motion-sensing keys for triggering a control instruction, wherein the operating event can be click, slide and the like, an application program is opened by clicking, and the volume is adjusted by sliding, and the like.

For a 3D coordinate system, segmentation processing is similar to that in the 2D rectangular coordinate system, unnecessary details are avoided, while the formed segmentation range is just three-dimensional.

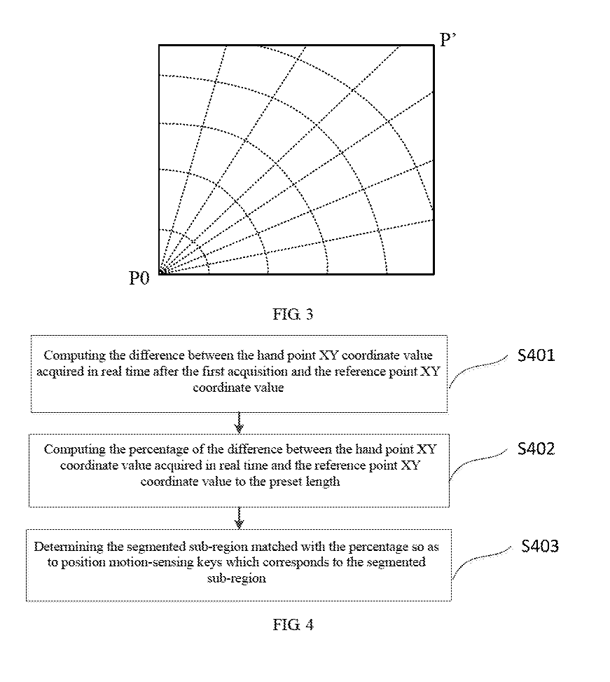

FIG. 3 shows a segmentation diagram of the present disclosure in the 2D polar coordinate system; specifically, if keys of 2D polar coordinate layout are set in the display interface, segmentation can be performed in the pre-defined region in the divergent direction from the center to outside by virtue of the polar diameter and polar angle by taking P0 as a polar coordinate so as to form a plurality of fan-shaped segmented sub-regions.

In the embodiment of the present disclosure, after the pre-defined region is segmented, the percentages of the segmented sub-regions that correspond to the motion-sensing keys in the pre-defined region are further computed according to the size of the motion-sensing keys. The step of computing the percentage of each segmented sub-region in the pre-defined region can include the sub-steps: computing a proportion according to the size of the motion-sensing keys and the display interface, taking the pre-defined region as a unit, acquiring the percentages of the corresponding segmented sub-regions in the pre-defined region according to the proportion of the motion-sensing keys, wherein the display interface can have the size of a display screen or a display interface which corresponds to the motion-sensing keys; the step also can include the sub-steps: computing the proportion according to the size of the segmented sub-regions segmented according to the motion-sensing keys and the pre-defined region, for example, computing a longitudinal proportion of sub-regions which correspond to the motion-sensing keys in the pre-defined region according to width of the motion-sensing keys in the longitudinal direction and the longitudinal width of the motion-sensing key display interface, and obtaining the corresponding percentage of each segmented sub-region according to the positions of the motion-sensing keys in the display interface.

As shown in the FIG. 2, after the pre-defined region is segmented according to a Sudoku layout, the percentage of each Sudoku region in the transverse direction and/or longitudinal direction is computed, for example, the percentage of each segmented sub-region in the transverse direction is computed, if the width of the display interface is 9*9, due to the same size of each motion-sensing key, the size of each segmented sub-region in the transverse and longitudinal directions is 3*3, the proportion of the segmented sub-region 1 in the transverse direction is obtained by dividing the transverse width of the motion-sensing keys by the transverse width of the display interface, namely 3/9, while the proportion of the segmented sub-region 1 in the longitudinal direction is obtained by dividing the longitudinal width of the motion-sensing keys by the longitudinal width of the display interface, namely 3/9; in a similar way the proportions of the segmented sub-region 2, the segmented sub-region 3, in the transverse direction and longitudinal direction are computed. If the proportion is computed in a manner of the segmented sub-regions and the pre-defined region, the proportion is computed by a method of dividing the transverse width of the segmented sub-regions by the pre-defined region, and unnecessary details are avoided.

After the proportion of each segmented sub-region is computed, a percentage range of each segmented sub-region is obtained according to the position relation of each motion-sensing key or segmented sub-region, for example, the segmented sub-region 1, the segmented sub-region 2 and the segmented sub-region 3 are arranged in the transverse direction from the left to right, the proportion of any one in the transverse direction is 1/3, the width of the pre-defined region in the transverse direction is taken as a unit, the percentage range of the segmented sub-region 1 in the transverse direction is 1-33.3%, the percentage range of the segmented sub-region 2 is 33.4-66.6%, and the percentage range of the segmented sub-region 3 is 66.7-100%; in the longitudinal direction, the segmented sub-region 1, the segmented sub-region 4 and the segmented sub-region 7 are arranged from top to bottom, the proportion of any one in the longitudinal direction is 1/3, the width of the pre-defined region in the longitudinal direction is taken as a unit, the percentage range of the segmented sub-region 1 in the longitudinal direction is 1-33.3%, the percentage range of the segmented sub-region 4 is 33.4-66.6%, and the percentage range of the segmented sub-region 7 is 66.7-100%; and the corresponding percentage range of the segmented sub-region 1 in the transverse direction is 1-33.3%, the corresponding percentage range of the segmented sub-region 1 in the longitudinal direction is also 1-33.3%. the corresponding percentage range of the segmented sub-region 2 in the transverse direction is 33.4-66.6%, the corresponding percentage range of the segmented sub-region 2 in the longitudinal direction is the previous corresponding percentage range of 1-33.3%, the corresponding percentage range of the segmented sub-region 3 in the transverse direction is 66.7-100%, the corresponding percentage range of the segmented sub-region 3 in the longitudinal direction is 1-33.3%, the corresponding percentage range of the segmented sub-region 4 in the transverse direction is 1-33.3%, the corresponding percentage range of the segmented sub-region 4 in the longitudinal direction is the previous corresponding percentage range of 33.4-66.6%, the corresponding percentage range of the segmented sub-region 7 in the transverse direction is 1-33.3%, and the corresponding percentage range of the segmented sub-region 7 in the longitudinal direction is 66.7-100%. In a similar way, the corresponding percentage ranges of the segmented sub-region 5, the segmented sub-region 6 and the segmented sub-region 8 and the segmented sub-region 9 can be computed, so unnecessary details are avoided.

S103, determining the corresponding segmented sub-regions according to the hand point coordinate values acquired in real time after the first acquisition and the reference point coordinate values so as to position the corresponding motion-sensing keys.

The acquisition device acquires hand points by taking the preset time length as a period, and when the reference point is determined and a new real-time hand point is acquired, the segmented sub-regions are determined according to the real-time hand point coordinate values and the reference point coordinate values. The operation of determining the segmented sub-regions according to the real-time and point coordinate values and the reference point coordinate values can adopt different methods, the segmented sub-regions can be directly determined according to coordinates of real-time hand points or also can be determined according to differences between the real-time hand point coordinate values and the reference point coordinate values, and the segmented sub-regions are determined by a method according to the differences between the real-time hand point coordinate values and the reference point coordinate values in the embodiment. Under different coordinate systems, different difference computation modes and positioning methods exist. In the embodiment of the present disclosure, the reference point coordinate values are determined according to the hand point coordinate values acquired at the first time in the step S101, and when the new hand point is subsequently acquired, the difference between the hand point coordinate value acquired in real time and the reference point coordinate values is computed, a segmented sub-region in which the real-time hand point drops is determined by computing the percentage of the difference to the preset length and matching the percentage with the percentage of the segmented sub-region so as to position the corresponding motion-sensing keys. Specifically, the coordinate value of the real-time hand point is contrasted with the reference point coordinate value to obtain a difference Δt, if the preset length is L, the percentage of the difference between the real-time hand point coordinate value and the reference point coordinate value to the preset length is obtained through Δt/L*100%, the percentage is matched with the percentage in the step S102 so as to determine the segmented sub-region in which the real-time hand point is positioned, so that the motion-sensing keys which correspond to the segmented sub-regions are positioned.

In the previous computation process, the condition that the difference Δt is greater than the preset length L is possibly caused due to large preset time length or large operating amplitude of the target object, then a percentage of more than 100% is obtained, and the segmented sub-region in which the percentage is positioned is positioned in a segmented sub-region on the optimal edge and motion-sensing keys in the optimal edge segmented sub-region are positioned. When the difference Δt is a negative number and greater than the preset length L, the motion-sensing keys are positioned in the segmented sub-region on the leftmost side or the uppermost side, and when the difference Δt is a positive number and greater than the preset length L, the motion-sensing keys are positioned in the segmented sub-region on the rightmost side or lowest side.

The motion-sensing key positioning method provided by the embodiment of the present disclosure includes the steps: segmenting and computing the pre-defined area so as to obtain corresponding percentages of the segmented sub-regions, and determining corresponding segmented sub-regions of the current operation according to the percentage calculated by the differences between the real-time hand point coordinate value and the reference point coordinate value so as to position the corresponding motion-sensing keys. Therefore, specific motion-sensing keys can be positioned based on the corresponding relations of the segmented sub-regions and the motion-sensing keys, and therefore, the hand shape does not need to be displayed; and meanwhile, direct operation can be performed by small-amplitude motion-sensing action only, the blank part is not clicked, and the errors in operation are reduced.

Description is given in the following embodiments by taking the operations of specifically positioning the motion-sensing keys in the 2D rectangular coordinate system and positioning the motion-sensing keys in the 2D polar coordinate system. However, in as 3D coordinate system, the operation can be performed by referring to the 2D rectangular coordinate system, and unnecessary details are avoided in the embodiments.

FIG. 4 shows a flow chart of motion-sensing key positioning in the embodiment I in the present disclosure; as shown in the FIG. 4, the embodiment can include the steps in the 2D rectangular coordinate system:

S401, computing the difference between the hand point XY coordinate value acquired real time after the first acquisition and the reference point XY coordinate value;

in the motion-sensing operation process, action change of the target object (such as limbs) is intuitively reflected through hand point transfer, namely the hand point position continuously changes, and transfer route or trace of the hand point can be tracked by virtue of the real-time hand point coordinate relative to the reference point coordinate. Therefore, in the 2D rectangular coordinate system, coordinate value change of the hand point in the transverse direction and longitudinal direction relative to the reference point can be intuitively reflected. Specifically, the x coordinate value of the real-time hand point is contrasted with the x coordinate value of the reference point to obtain a difference Δx, and the y coordinate value of the real-time hand point is contrasted with the y coordinate value of the reference point to obtain a difference Δy;

S402, computing the percentage of the difference between the hand point XY coordinate value acquired in real time and the reference point XY coordinate value to the preset length;
in order to subsequently and directly position the motion-sensing keys, in the embodiment, the difference obtained in the previous step S401 and the preset length are subjected to percentage computation, the total preset length can be set according to needs or size arrangement of the motion-sensing keys, in order to obtain small operating amplitude of the target object and accurate identification, the preset length can be set to be small, otherwise large; if the motion-sensing keys are small and compactly arranged, the preset length can be set to be small, otherwise large. The Δx and Δy are respectively substituted into Δt/L*100% so as to compute the percentages on the X and Y coordinates. The percentages and each segmented sub-region have one-to-one relationships;

Step S403, determining the segmented sub-regions matched with the percentage so as to position the motion-sensing keys which correspond to the segmented sub-regions;
in the embodiment, the percentages determined in the step S402 and the segmented sub-regions have one-to-one relationships: and therefore, the segmented sub-region in which the real-time hand point is positioned at current moment and motion-sensing keys which correspond to the segmented sub-region can be obtained by respectively determining the percentages on the XY coordinates only, and after the selected motion-sensing keys are determined, the operating time of the target object can be further identified so as to confirm the triggered control instruction of the motion-sensing key.

FIG. 5 shows the flow chart of the motion-sensing key positioning in the embodiment II of the present disclosure; as shown in the FIG. 5, the embodiment can include the steps in the 2D polar coordinate system:

S501, computing the difference between the hand point polar coordinate value acquired in real time after the first acquisition and the reference point polar coordinate value;

S502, computing the percentage of the difference between the hand point polar coordinate value acquired in real time and the reference point polar coordinate value to the preset length;

S503, positioning the segmented sub-region in which the percentage is positioned so as to position the motion-sensing keys that correspond to the segmented sub-region.

Data processing is performed in a related polar coordinate system based on the polar angle and polar diameter. Unnecessary details are avoided.

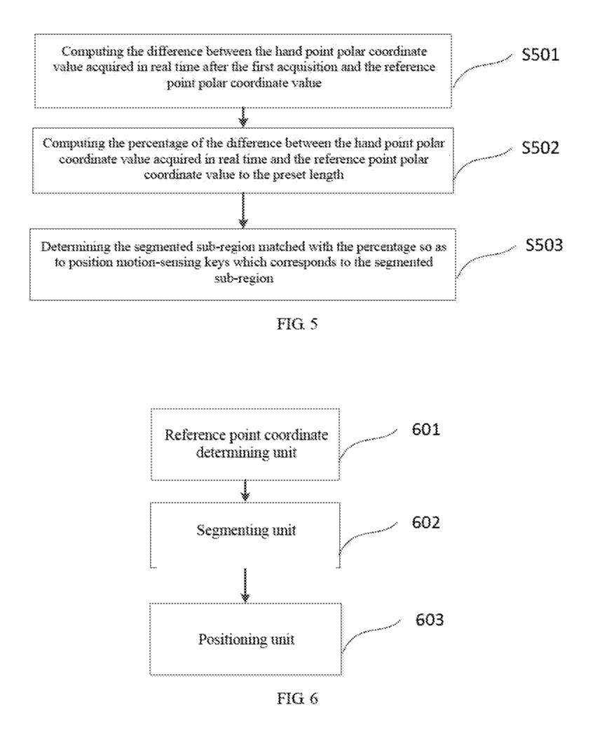

The present disclosure also discloses a motion-sensing key positioning device. FIG. 6 shows a structure diagram of the motion-sensing key positioning device provided by the embodiment of the present disclosure; as shown in the FIG. 6, in the embodiment, the device can include a reference point coordinate determining unit 601, a segmenting unit 602 and a positioning unit 603, wherein;

the reference point coordinate determining unit 601 is used for determining the reference point coordinate values of all the motion-sensing keys according to the hand point coordinate value acquired at the first time;
the segmenting unit 602 is used for segmenting the pre-defined region so as to obtain segmented sub-regions according to the layout of the motion-sensing keys;
and the positioning unit 603 is used for determining the corresponding segmented sub-regions according to the hand point coordinate value acquired in real time after the first acquisition and the reference point coordinate value so as to position the corresponding motion-sensing keys;
preferably, in another embodiment of the present disclosure, the reference point coordinate determining unit 601 is also used for determining a preset length by taking the hand point coordinate acquired at the first time as a center and subtracting one half of the preset length from the hand point coordinate value acquired at the first time so as to obtain the reference point coordinate values of all the motion-sensing keys.

Preferably, in another embodiment of the present disclosure, the segmenting unit 602 is further used for segmenting the pre-defined region along the layout of the motion-sensing keys so as to obtain segmented sub-regions of which the number corresponds to that of the motion-sensing keys according to the layout and number of the motion-sensing keys, wherein the layout of the motion-sensing keys includes the position relation, size and layout direction of the motion-sensing keys.

Furthermore, in another embodiment of the present disclosure, the segmenting unit 602 is further used for segmenting the preset region along the transverse direction so as to obtain segmented sub-regions of which the number corresponds to that of the motion-sensing keys in the transverse direction according to the number of the motion-sensing keys in the transverse direction; and/or segmenting the preset region along the longitudinal direction so as to obtain segmented sub-regions of which the number corresponds to that of the motion-sensing keys in the longitudinal direction according to the number of the motion-sensing keys in the longitudinal direction.

Furthermore, in another embodiment of the present disclosure, the segmenting unit 602 is further used for computing the percentage of the segmented sub-regions that correspond to the motion-sensing keys in the pre-defined region according to the size of the motion-sensing keys.

Furthermore, in another embodiment of the present disclosure, the positioning unit 603 is further used for computing the difference between the hand point coordinate value acquired in real time after the first acquisition and the reference point coordinate value; computing the percentage of the difference between the hand point coordinate value acquired in real time and the reference point coordinate value to the preset length; and determining the segmented sub-region matched with the percentage so as to position the motion-sensing keys that correspond to the segmented sub-region.

Furthermore, in another embodiment of the present disclosure, the positioning unit 603 is further used for positioning the segmented sub-region in which the percentage is positioned to be an optimal edge segmented sub-region and positioning the motion-sensing keys that correspond to the optimal edge segmented sub-region when the percentage is greater than 100%.

The device in the embodiments of the present disclosure specifically can realize related function modules by virtue of a hardware processor.

The embodiments of the device described above are only schematic, wherein units serving as separate parts to describe can be physically separated, and parts serving as units to display can be physical units, namely the parts can be positioned in the same place or can be distributed onto multiple network units. Partial or total modules can be selected to achieve the aims of the scheme in the embodiments according to actual needs. The common technicians in the field can understand and implement under the condition that the creative labor is not contributed.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

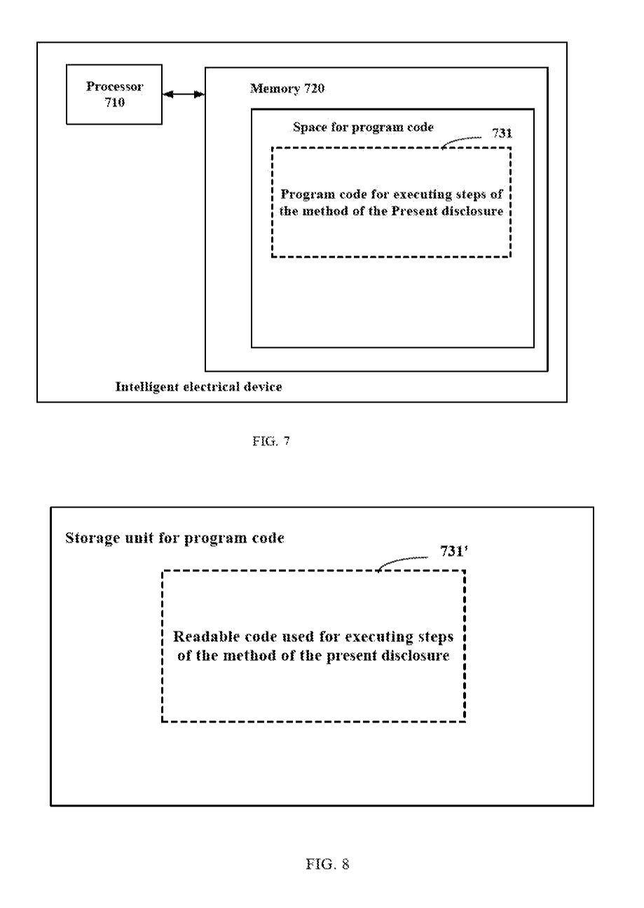

For example, FIG. 7 illustrates a block diagram of an intelligent electrical device for executing the motion-sensing key positioning method according the disclosure. Traditionally, the intelligent electrical device includes a processor 710 and a computer program product or a computer readable medium in form of a memory 720. The memory 720 could be electronic memories such as flash memory, EEPROM (Electrically Erasable Programmable Read—Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which can be read for example by processors 710. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The final description is that the previous embodiments are not used for limiting the technical scheme of the present disclosure, but only for describing. Although detailed description of the present disclosure is given with reference to the previous embodiments, the common technicians in the field should understand that the technical scheme recorded by each of the previous embodiments can be modified, or one part of technical characteristics can be equivalently replaced; however, the modification or replacement does not enable the essence of the corresponding technical scheme to get out of the spirit and scope of the technical scheme in each embodiment of the present disclosure.

What is claimed is:

1. A motion-sensing key positioning method, comprising:
determining reference point coordinate values of motion-sensing keys according to hand point coordinate values acquired at a first time;
segmenting a pre-defined region to obtain segmented sub-regions according to layout of the motion-sensing keys;
determining corresponding segmented sub-regions according to differences between the hand point coordinate values acquired in real time after the first time acquisition and reference point coordinate values so as to position the corresponding motion-sensing keys.

2. The method according to the claim 1, wherein the step of determining the reference point coordinate values of the motion-sensing keys according to the hand point coordinate values acquired at the first time comprises:
determining a preset length by taking a hand point coordinate acquired at the first time as a center;
subtracting, one half of the preset length from the hand point coordinate value acquired at the first time so as to obtain the reference point coordinate value of all the motion-sensing keys.

3. The method according to the claim 1, wherein the step of segmenting the pre-defined region so as to obtain the segmented sub-regions according to the layout of the motion-sensing keys comprises:
segmenting the pre-defined region along a layout direction of the motion-sensing keys so as to obtain segmented sub-regions of which the number corresponds to that of the motion-sensing keys according to the layout and number of the motion-sensing keys, wherein the layout of the motion-sensing keys comprises a position relation, a size and the layout direction of the motion-sensing keys.

4. The method according to the claim 3, wherein the step of segmenting the pre-defined region along the layout direction of the motion-sensing keys so as to obtain the segmented sub-regions of which the number corresponds to that of the motion-sensing keys according to the layout and number of the motion-sensing keys comprises:
segmenting the preset region along a transverse direction so as to obtain segmented sub-regions of which the number corresponds to that of the motion-sensing keys in the transverse direction according to the number of the motion-sensing keys in the transverse direction; and/or
segmenting the preset region along a longitudinal direction so as to obtain segmented sub-regions of which the number corresponds to that of the motion-sensing keys in the longitudinal direction according to the number of the motion-sensing keys in the longitudinal direction.

5. The method according to the claim 1, wherein the step of segmenting the pre-defined region to obtain segmented sub-regions according to the layout of the motion-sensing keys comprises:
computing the percentages of the segmented sub-regions which correspond to the motion-sensing keys in the pre-defined region according to a size of the motion-sensing keys,

6. The method according to the claim 1, wherein the step of determining the corresponding segmented sub-regions according to the hand point coordinate values acquired in real time after the first time acquisition and the reference point coordinate values so as to position the corresponding motion-sensing keys comprises:
computing the difference between the hand point coordinate value acquired in real time after the first time hand point acquisition and the reference point coordinate value;
computing the percentage of the difference between the hand point coordinate value acquired in real time and the reference point coordinate value to the preset length;
determining the segmented sub-region matched with the percentage so as to position motion-sensing keys which correspond to the segmented sub-region.

7. The method according to the claim 6, wherein the step of determining the segmented sub-region matched with the percentage so as to position motion-sensing keys which correspond to the segmented sub-region comprises:
positioning the segmented sub-region in which the percentage is positioned to be an optimal edge segmented sub-region and positioning the motion-sensing keys which correspond to the optimal edge segmented sub-region when the percentage is greater than 100%.

8. An intelligent electrical device for motion-sensing key positioning, comprising:
a memory having instructions stored thereon;
a processor configured to execute the instructions to perform operations for motion-sensing key positioning, comprising:
determining reference point coordinate values of all motion-sensing keys according to hand point coordinate values acquired at a first time;
segmenting a pre-defined region so as to obtain segmented sub-regions according to layout of the motion-sensing keys;
determining corresponding segmented sub-regions according to hand point coordinate values acquired in real time after a first acquisition and a reference point coordinate value so as to position corresponding motion-sensing keys.

9. The intelligent electrical device according to the claim 8, wherein segmenting a pre-defined region so as to obtain segmented sub-regions according to layout of the motion-sensing keys comprises:
segmenting the pre-defined region along a layout direction of the motion-sensing keys so as to obtain the segmented sub-regions of which the number corresponds to that of the motion-sensing keys according to the layout and number of the motion-sensing keys, wherein the layout of the motion-sensing keys comprises a position relation, a size and a layout direction of the motion-sensing keys.

10. The intelligent electrical device according to the claim 8, wherein segmenting a pre-defined region so as to obtain segmented sub-regions according to layout of the motion-sensing keys further comprises:
computing a percentage of the segmented sub-regions which correspond to the motion-sensing keys in the pre-defined region according to the size of the motion-sensing keys.

11. The intelligent electrical device according to the claim 8, wherein determining corresponding segmented sub-regions according to hand point coordinate values acquired in real time after a first acquisition and a reference point coordinate value so as to position corresponding motion-sensing keys further comprises:
computing the difference between the hand point coordinate value acquired in real time after the first acquisition and the reference point coordinate value;
computing a. percentage of the difference between the hand point coordinate value acquired in real time and the reference point coordinate value to the preset length;
positioning the segmented sub-region in which the percentage is positioned and motion-sensing keys which correspond to the segmented sub-region.

12. A non-transitory computer readable medium, having computer programs stored thereon that, when executed by one or more processors of an intelligent electrical device, cause the intelligent electrical device to perform:
determining reference point coordinate values of all motion-sensing keys according to hand point coordinate values acquired at the first time
segmenting a pre-defined region to obtain segmented sub-regions according to the layout of the motion-sensing keys;
determining corresponding segmented sub-regions according to differences between the hand point coordinate values acquired in real time after the first acquisition and the reference point coordinate values so as to position the corresponding motion-sensing keys.
